(19) United States
(12) Patent Application Publication
(10) Pub. No.: US 2011/0315172 A1
(43) Pub. Date: Dec. 29, 2011

(54) THEMED VEHICLE WASHING SYSTEM WITH ANIMATRONIC WASHING COMPONENTS

(76) Inventor: G. Thomas Ennis, Inglewood, CA (US)

(21) Appl. No.: 13/099,193

(22) Filed: May 2, 2011

Related U.S. Application Data
(60) Provisional application No. 61/330,720, filed on May 3, 2010.

(51) Int. Cl. B08B 3/00

(52) U.S. Cl. 134/123

(57) ABSTRACT

Described is a themed vehicle washing system with animatronic washing components. The themed vehicle washing system includes a cohesive theme therethrough and an audio track that is coordinated with the theme. Additionally, an animatronic washing component is included that is coordinated with the theme. Thus, in addition to providing entertainment, the animatronic washing component is formed to provide a washing function.

### PRIORITY CLAIM

This is a non-provisional patent application, claiming the benefit of priority of U.S. Provisional Application No. 61/330,720, filed on May 3, 2010, entitled, “Themed Vehicle Washing System with Animatronic Washing Components.”

### BACKGROUND OF THE INVENTION

(1) Field of Invention

The present invention relates to an amusement ride and, more particularly, to an amusement ride that operates as a themed vehicle washing system with animatronic washing components that correspond to the theme.

(2) Description of Related Art

Vehicle washing systems have long been known in the art. By way of example, automatic vehicle-washing systems are well-known and are in widespread use for washing passenger automobiles, trucks, buses, railroad equipment, and the like. A typical system includes a conveyor for moving the vehicle through the installation, and a series of power-driven brushes which are moved around the vehicle under a drenching spray of water and soap or detergent to remove dirt and grease. The washed vehicle is given a spray of clean rinse water, and is then moved to a drying station. Finally, after being washed and dried, the conveyor pushes the vehicle from the washing system.

While operable for washing the vehicle, traditional vehicle washing systems are largely bland machines that do not engage or otherwise entertain the users. More specifically, as a driver navigates a vehicle through a traditional vehicle washing system, nothing therein is specifically designed to entertain the driver while simultaneously washing the vehicle.

Thus, a continuing need exists for a themed vehicle washing system that includes animatronic washing components that are provided to wash the vehicle while entertaining a user.

### SUMMARY OF INVENTION

While considering the failure of others to make use of all of the above components in this technology space, the inventor unexpectedly realized that a themed vehicle washing system with animatronic washing components could be used to wash a vehicle while simultaneously entertaining a user.

The themed vehicle washing system comprises a vehicle washing system that includes a cohesive theme therethrough and one or more animatronic washing components. Each of the animatronic washing components is a themed feature that is coordinated with the theme. In addition to being a themed item (e.g., an elephant), each animatronic washing component is formed to provide a washing function to a user's vehicle; such as an elephant that sprays a soap solution onto a passing vehicle. Other examples of animatronic washing components include a rock spraying a fluid and a monkey waving a wipe cloth.

To enhance the entertainment value of the themed vehicle washing system, an audio system is provided that includes an audio track that is coordinated with the theme. In one aspect, the audio system transmits the audio track through a radio signal to a vehicle passing through the vehicle washing system. Importantly, the audio track includes an audio feature that corresponds with the themed feature. The audio system plays the audio feature when the vehicle is proximate the corresponding themed feature. For example, the sounds of an elephant trumpeting are played when the vehicle passes an elephant that is spraying the soap solution onto the user's vehicle.

To track the progress of the vehicle through the washing system, a plurality of sensors can be provided. Each sensor is positioned to determine the vehicle's proximity to a themed feature. Further, the audio track includes a plurality of sub-tracks, with the audio system further configured to play a sub-track that corresponds to the themed feature as the vehicle approaches the themed feature.

As can be appreciated, it may be desirable to allow multiple vehicles to use the themed vehicle washing system simultaneously. Thus, the audio system is operable for providing a first audio identifier to a first vehicle and a second audio identifier to a second vehicle. Each audio identifier indicates a distinct transmission by which the driver of the first vehicle can listen to a first sub-track while the driver of the second vehicle can listen to a second sub-track.

Finally, as can be appreciated by one in the art, the present invention also comprises a method for forming and using the invention described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is an illustration of an entry point into a themed vehicle washing system;

FIG. 2 is an illustration depicting various animatronic washing components of the themed vehicle washing system;

FIG. 3 is an illustration of an animatronic washing component;

FIG. 4 is an illustration depicting a first vehicle as entering the themed vehicle washing system;

FIG. 5 is an illustration depicting a second vehicle as entering the themed vehicle washing system; and

FIG. 6 is an illustration of an audio system according to the present invention.

### DETAILED DESCRIPTION

The present invention relates to a vehicle washing system and, more particularly, to a themed vehicle washing system with animatronic washing components that correspond to the theme. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction.

Instead, they are used to reflect relative locations and/or directions between various portions of an object.

(1) Introduction

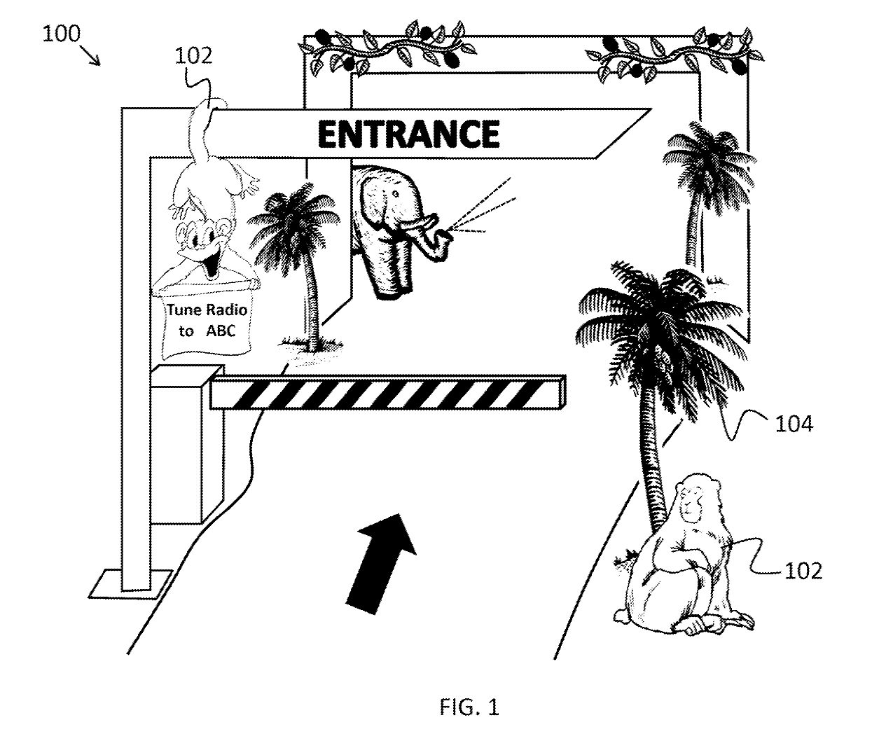

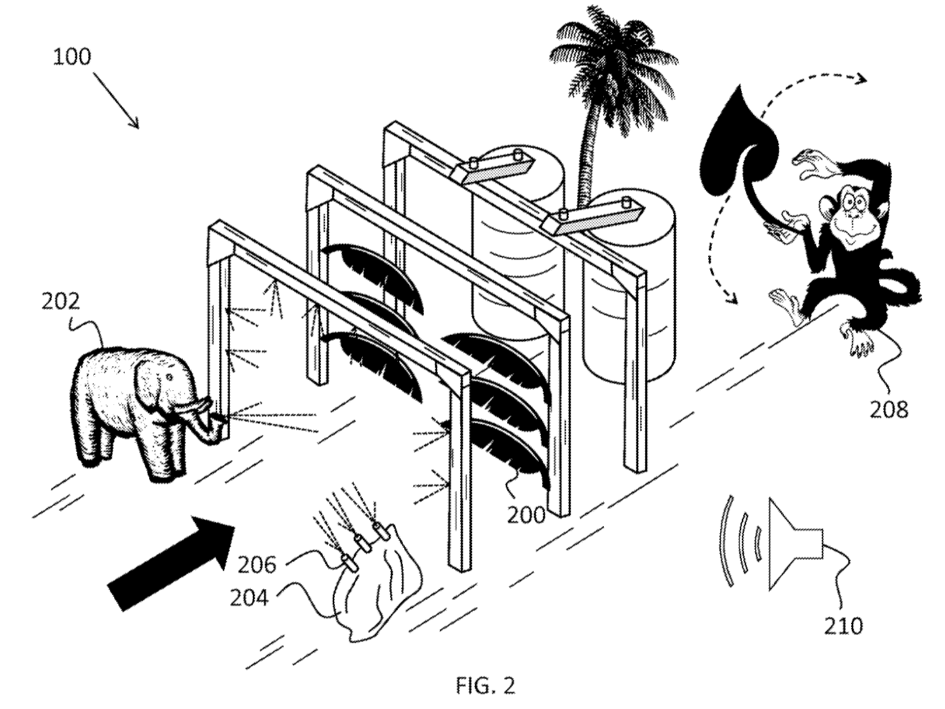

As shown in FIGS. 1 and 2, the present invention is directed to a themed vehicle washing system 100 that includes a vehicle washing system with a cohesive theme and animatronic washing components that correspond to the theme. The vehicle washing system includes standard washing items that would be typically found in a car wash, non-limiting examples of which include sprayers, dispensers, brushes, blowers, etc. However, importantly, the themed vehicle washing system 100 operates as an entertainment system that is operable for entertaining a user within a vehicle as the vehicle passes through the themed vehicle washing system 100.

As can be appreciated by one skilled in the art, the themed vehicle washing system 100 can be formed in any desirable theme, non-limiting examples of which include an eco-jungle theme, space theme, dinosaur theme, alien theme, etc. In being a themed washing system, the washing components are painted and decorated to correspond to the theme. For example, if it is an eco-jungle theme, many of the components can be painted green.

Further and as shown in FIGS. 1 and 2, theme decorations and animatronics are included that provide both aesthetic realism to the theme and/or washing functions. For example, FIG. 1 depicts an entrance to the themed vehicle washing system 100. As shown, figurines 102 and corresponding vegetation 104 can be positioned around the entrance to introduce the theme of the themed vehicle washing system 100. In this non-limiting example, the figurines 102 are monkeys while the vegetation 104 includes palm trees, vines, etc. Thus, based on the figurines 102 and vegetation 104, a user would easily deduce that the theme of this particular themed vehicle washing system 100 is a jungle theme. It should be understood that the term “figurine” as used herein is intended to refer to an object that is formed to simulate the appearance of any suitable type of animate entity, non-limiting examples of which include animals, humans, aliens, etc.

The figurine can be a stationary figurine or animatronic. If animatronic, the figurine can be formed simply for aesthetic purposes, such as a waving monkey, or for functional purposes and operate as an animatronic washing component.

The animatronic washing component is any item that is formed to simulate something that corresponds with the theme, yet provides a washing function for a passing vehicle. Examples of animatronic washing components are further depicted in FIG. 2, which illustrates an inside of the themed vehicle washing system 100.

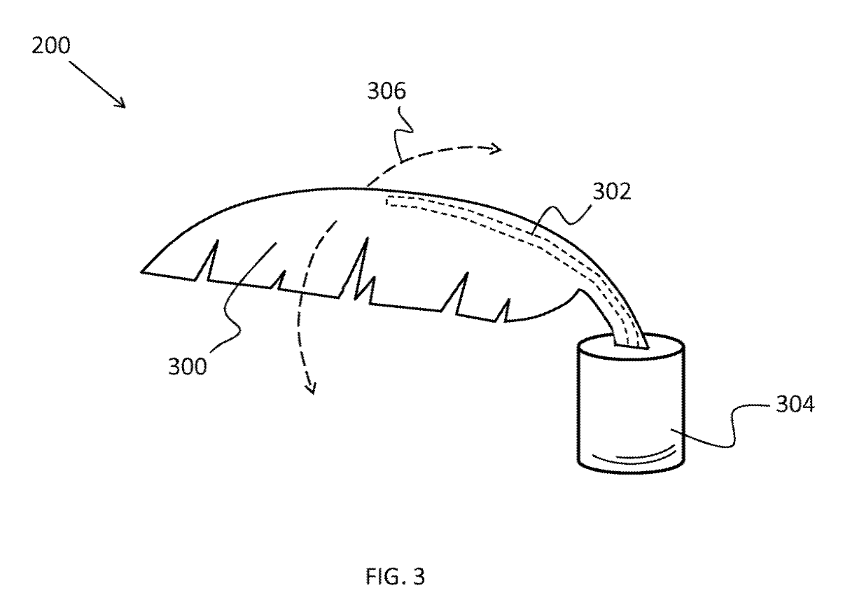

As a non-limiting example and as depicted in FIG. 2, the animatronic washing component can be faux vegetation 200 (e.g., faux palm frond) that is able to swing from side-to-side while wiping down a passing vehicle. In this example and as depicted in FIG. 3, the faux vegetation can 200 be made of soft fabric 300 that is wrapped around a more stable frame 302 (e.g., PVC). The frame 302 is connected with a motor 304 or other movement means for causing the faux vegetation to move from side-to-side 306. As can be understood by one skilled in the art, the faux vegetation described herein is just one non-limiting example of a suitable animatronic washing component, as the present invention is not intended to be limited thereto and can include any number and type of animatronic washing components.

Importantly, the animatronic washing component is operable to both simulate an item that corresponds with the theme and provide a vehicle washing function. Referring again to FIG. 2, the faux vegetation 200 is positioned in the path of the vehicle such that its side-to-side motion causes the faux vegetation 200 to actually wipe (e.g., scrub, etc.) a passing vehicle as it engages with the faux vegetation 200.

As another example, an elephant 202 (or any other suitable figurine) can be included that shoots water from its trunk to wash or dowse a passing vehicle. In this aspect, the elephant 202 includes a hose or piping that passes through its body to spray fluid (e.g., water, soap solution, wax, etc.) from a reservoir, out the elephant's 202 trunk and onto a passing vehicle.

Yet another non-limiting example of an animatronic washing component is a rock 204. The rock 204 in this example is formed to include nozzles 206 protruding therefrom. Each of the nozzles 206 is connected with a hose or piping that passes through the rock 204 to spray fluid from a reservoir and onto a passing vehicle.

As another example, a monkey 208 (or any other suitable figurine) can be included to wipe down a vehicle. In this aspect, the monkey 208 is waving (or holding) a wipe cloth (shaped like a palm frond) that is used to wipe down the passing vehicle. The monkey 208 is holding the wipe cloth in any suitable manner such that it causes the wipe cloth to engage with a passing vehicle. For example, the monkey 208 is stationary and simply holds the wipe cloth in the pathway of the vehicle. As another non-limiting example, the monkey 208 includes pivotally attached arms with corresponding motors and/or controllers that cause the arms to pivot, thereby waving the wipe cloth across a passing vehicle.

Thus, as can be appreciated by one skilled in the art, a number of animatronic washing components can be employed that are coordinated with the theme and that provide washing functions that would be typically found in a vehicle washing system, non-limiting examples of which include spraying water and/or soap, wiping a vehicle, etc.

Additionally, to further enhance the entertainment aspect, the system can include an audio system 210 that is coordinated with the theme. For example, an eco-jungle theme can include a jungle soundtrack with animal sounds that are played while a user navigates their vehicle through the themed vehicle washing system 100. Similarly, a dinosaur theme would include an audio soundtrack with dinosaur growls, etc., while an alien theme may include an audio soundtrack with space ship sounds.

In its most simple aspect, the audio system 210 includes an audio sound track that is simply turned on to play over a loud speaker system. As can be appreciated, continuous play of an audio track can become a nuisance for employees and neighbors of the themed vehicle washing system 100. As such, the audio system 210 also includes a transmission system to enable users to listen to the audio sound track in the privacy of their vehicle as the vehicle passes through the vehicle washing system. The transmission system is any suitable system that is capable of transmitting an audio signal that is to be picked up by another device. A non-limiting example of such a transmission system includes a radio-frequency (RF) transmitter system that transmits the audio sound track as a radio signal to be picked up by the vehicle's RF receiver. Thus, the user can tune their stereo to the predetermined channel and listen to the audio sound track.

The audio system 210 can be formed to play a single audio soundtrack that is received and listened to by all users simultaneously. However, in some circumstances, it may be desirable to play more than one audio soundtrack at one time. For example, if two or more vehicles are in the themed vehicle washing system, it may be desirable to have the occupants of each vehicle listen to a different portion of the audio soundtrack. By way of example, if the themed vehicle washing system is a jungle theme, it may be desirable to listen to the trumpets of an elephant while passing the elephant and, similarly, listen to the chirps of monkeys while passing the monkey. As such, each vehicle would need to start the audio soundtrack at different times such that the audio soundtrack is coordinated with each vehicle's position within the themed vehicle washing system 100.

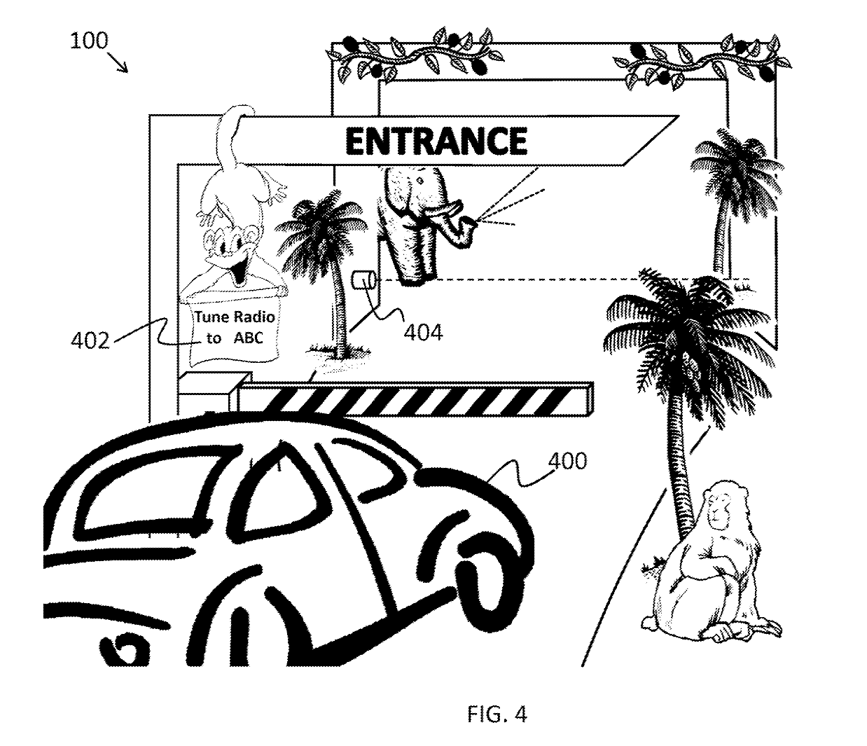

In order to accomplish a unique audio experience that is coordinated with each vehicle as it passes through the themed vehicle washing system, the audio system 210 can be enhanced to generate a unique transmission identifier for use by each vehicle. For example and as depicted in FIG. 4, as a first vehicle 400 approaches (or enters) the themed vehicle washing system 100, a first audio identifier 402 is provided to the driver. In this non-limiting example, the first audio identifier 402 is an RF channel to which the driver can tune their vehicle stereo and listen to the audio track. The first audio identifier 402 is provided to the driver using any suitable display or transmission technique, a non-limiting example of which includes an LED display. As the first vehicle 400 enters the themed vehicle washing system 100, the audio track is initiated and played according to the first audio identifier 402. For example, if the driver were to tune their radio to Channel ABC, they would be able to hear the audio track that is coordinated with the themed vehicle washing system 100 and that includes audio components that are coordinated with the various themed features (e.g., animatronic washing component).

Importantly, the audio components are synchronized with the vehicle's position within the themed car washing system. For example, the audio track has a play time that is reflective of the amount of time that it takes for the vehicle to pass through the vehicle washing system. In other words, the audio track, when recorded, includes audio features (e.g., elephants trumpeting) that are positioned within the audio track play time such that the audio feature plays when the vehicle passes the corresponding themed feature (e.g., animatronic washing component) in the themed vehicle washing system 100.

Alternatively, the audio track can include several sub-tracks, each of which is played when the vehicle is in a particular position. In this aspect, the themed vehicle washing system 100 includes several sensors 404 that are capable of detecting the vehicle's position with the washing system 100. The sensors 404 are any suitable sensors that are capable of detecting the presence of an object, a non-limiting example of which includes an infrared beam sensor. For example, when the first vehicle 400 passes a first sensor, an audio track of an elephant trumpeting is played over Channel ABC. As the first vehicle 400 passes a second sensor that is positioned proximate a monkey, an audio track of monkeys chirping is played over Channel ABC.

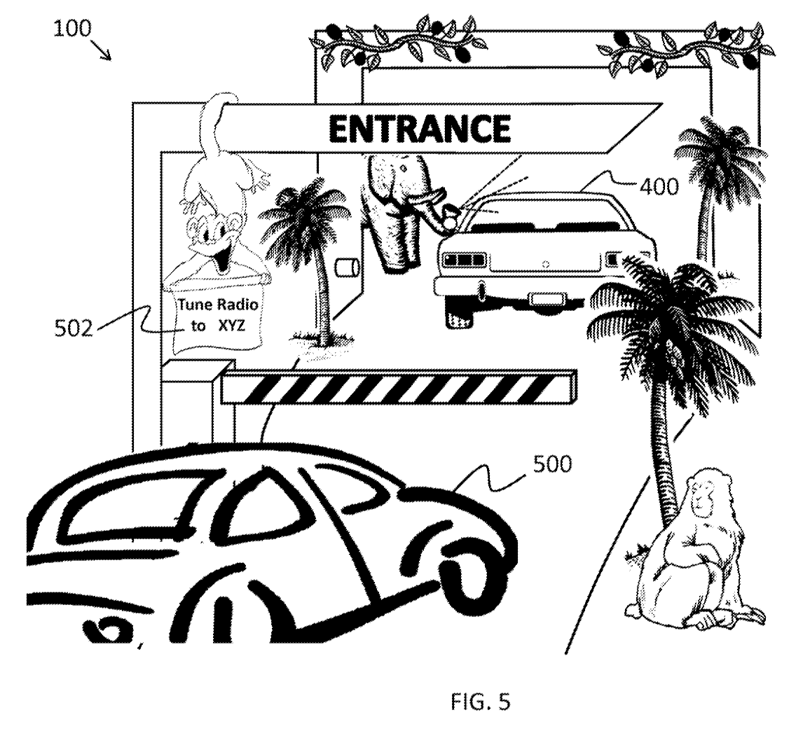

Thereafter and as depicted in FIG. 5, a second vehicle 500 approaches the themed vehicle washing system 100 and is provided with a second audio identifier 502 (e.g., Channel XYZ) that is different than the first audio identifier. Thus, the audio files that are coordinated with the second vehicle's 500 position within the themed vehicle washing system 100 are transmitted to the second vehicle 500 using the second audio identifier 502. For example, the driver of the second vehicle 500 can listen to the corresponding audio track on Channel XYZ, while the driver of the first vehicle 400 listens to the audio track on Channel ABC.

Using the non-limiting example as provided above, when the first vehicle 400 passes a second sensor that is positioned proximate a monkey, an audio track of monkeys chirping is played over Channel ABC; meanwhile, the second vehicle 500 passes the first sensor (which is proximate the elephant), which causes the audio system to play an audio track of elephants trumpeting over Channel XYZ. Thus, using the audio system, multiple vehicles can simultaneously pass through the themed vehicle washing system and listen to an audio track that corresponds to each vehicle's position within the vehicle washing system.

As can be appreciated by one skilled in the art, any suitable number of audio identifiers can be assigned and tracked by the audio system. Once a vehicle has exited the system, the audio identifier can be reused and reassigned to a new incoming vehicle. As a non-limiting example, if the sub-tracks are to be played in a consecutive series, once the final audio sub-track has been played, the corresponding audio identifier can be re-assigned to a new incoming vehicle.

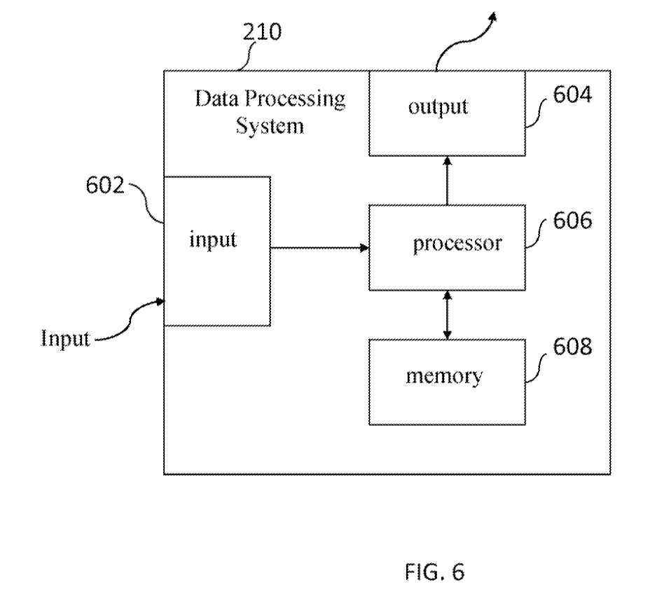

A block diagram depicting the components of the audio system 210 is provided in FIG. 6. The audio system 210 comprises an input 602 for receiving information from at least one sensor for use in determining a vehicle's position within the themed vehicle washing system. Note that the input 602 may include multiple “ports.” Typically, input is received from at least one sensor, non-limiting examples of which include an infrared beam sensor. An output 604 is connected with the processor for providing the audio track (and sub-tracks) for transmission to the vehicles. Output may also be provided to other devices or other programs; e.g., to other software modules, for use therein. The input 602 and the output 604 are both coupled with a processor 606, which may be a general-purpose computer processor or a specialized processor designed specifically for use with the present invention. The processor 606 is coupled with a memory 608 to permit storage of data and software that are to be manipulated by commands to the processor 606. The memory 608 also includes the audio track and/or sub tracks that are selected by the processor 606 for transmission.

As can be appreciated by one skilled in the art, the audio system described above can also be connected with lighting components so that various lighting features are activated that correspond to the audio track (or sub-track) and/or themed features. For example, if the vehicle passes through a waterfall, it may be desirable to play an audio sub-track of a rain storm with lightening. Simultaneously, the system can activate a flashing light to simulate lightening. Thus, the present invention provides for a unique washing system that is capable of washing a vehicle while entertaining the vehicle's occupants.

What is claimed is:

1. A themed vehicle washing system, comprising:
a vehicle washing system that includes a cohesive theme therethrough;
an animatronic washing component that is a themed feature that is coordinated with the theme, the animatronic washing component formed to provide a washing function to a user's vehicle.

2. The themed vehicle washing system as set forth in claim 1, further comprising an audio system that includes an audio track that is coordinated with the theme.

3. The themed vehicle washing system as set forth in claim 2, wherein the audio system transmits the audio track through a radio signal to a vehicle passing through the vehicle washing system.

4. The themed vehicle washing system as set forth in claim 3, wherein the audio track includes an audio feature that corresponds with the themed feature.

5. The themed vehicle washing system as set forth in claim 4, wherein the audio system plays the audio track such that the audio feature plays when the vehicle is proximate the corresponding themed feature.

6. The themed vehicle washing system as set forth in claim 5, further comprising a plurality of sensors, each sensor positioned to determine the vehicle's proximity to a themed feature, and wherein the audio track includes a plurality of sub-tracks, with the audio system further configured to play a sub-track that corresponds to the themed feature as the vehicle approaches the themed feature.

7. The themed vehicle washing system as set forth in claim 6, wherein the audio system is operable for providing a first audio identifier to a first vehicle and a second audio identifier to a second vehicle, each audio identifier indicating a distinct transmission by which the driver of the first vehicle can listen to a first sub-track while the driver of the second vehicle can listen to a second sub-track.

8. The themed vehicle washing system as set forth in claim 7, wherein the animatronic washing component includes a component selected from a group consisting of an elephant spraying a fluid, a rock spraying a fluid, and a monkey waving a wipe cloth.

9. The themed vehicle washing system as set forth in claim 2, wherein the audio track includes an audio feature that corresponds with the themed feature.

10. The themed vehicle washing system as set forth in claim 9, wherein the audio system plays the audio track such that the audio feature plays when the vehicle is proximate the corresponding themed feature.

11. The themed vehicle washing system as set forth in claim 2, further comprising a plurality of sensors, each sensor positioned to determine the vehicle's proximity to a themed feature, and wherein the audio track includes a plurality of sub-tracks, with the audio system further configured to play a sub-track that corresponds to the themed feature as the vehicle approaches the themed feature.

12. The themed vehicle washing system as set forth in claim 2, wherein the audio system is operable for providing a first audio identifier to a first vehicle and a second audio identifier to a second vehicle, each audio identifier indicating a distinct transmission by which the driver of the first vehicle can listen to an audio track while the driver of the second vehicle can listen to a different portion of the audio track.

13. The themed vehicle washing system as set forth in claim 1, wherein the animatronic washing component includes a component selected from a group consisting of an elephant spraying a fluid, a rock spraying a fluid, and a monkey waving a wipe cloth.
